(19) United States
(12) Patent Application Publication
(10) Pub. No.: US 2009/0313307 A1
(43) Pub. Date: Dec. 17, 2009

(54) MANIPULATION OF NETWORK MANAGEMENT INFORMATION

(75) Inventors: John POWER, Waterford (IE); Edwin Tse, Montreal (CA)

Correspondence Address: HARRITY & HARRITY, LLP, 11350 RANDOM HILLS RD., SUITE 600, FAIRFAX, VA, 22030, US

(73) Assignee: Telefonaktiebolaget LM Ericsson, Stockholm (SE)

(21) Appl. No.: 12/139,748

(22) Filed: Jun. 16, 2008

(51) Int. Cl. G06F 17/30

(52) U.S. Cl. 707/200; 707/E17.009

(57) ABSTRACT

A device associated with a network receives a request to modify a sub-attribute of an attribute associated with a software object that represents one of a representation of a managed resource or a collection of attributes associated with the managed resource. The device also modifies the sub-attribute of the software object based on the request, and sends a notification about the sub-attribute that has been modified.

### TECHNICAL FIELD

Embodiments described herein relate generally to communication systems, and, more particularly, to manipulation of network management information in a telecommunication system.

### BACKGROUND

Current network management solutions for telecommunication systems may include the International Telecommunication Union Telecommunication Standardization Sector's (ITU-T) Telecommunication Management Network (TMN), the Third Generation Partnership Project's (3GPP) Integration Reference Point, the Third Generation Partnership Project 2's (3GPP2) Integration Reference Point, and the Internet Engineering Task Force's (IETF) Simple Network Management Protocol (SNMP). Current network management solutions for telecommunication systems use a client-server, hierarchical architecture to manage flow of network management information (NMI) (e.g., information associated with operation, administration, maintenance, provisioning, etc. of telecommunication systems). For example, each level of the client-server, hierarchical architecture maintains a database of software objects. Each software object may include a representation of a managed resource (e.g., a network node under management, a network function under management, a network communication link under management, etc.). In telecommunication system management, a “representation of a managed resource” may include a collection of attributes associated with a managed resource, such as its Distinguished Name (e.g., a unique name for an entry in a Directory Service), its operational state, its alarm state, its number of partner node connections, etc. Software objects may be stored in a database created and/or maintained by a server. Such a database may be referred to as a Management Information Base (MIB).

In client-server, hierarchical architectures, a client manages a managed network (e.g., one or more nodes in a managed network) by manipulating content of the MIB. For example, to switch a node off-line, the client may invoke an operation (e.g., from a server) requesting a change of a state attribute (e.g., from on-line to off-line) associated with the node's software object. The server receives the requesting operation, issues a command to the node that switches the node to off-line, and changes the state attribute of the node's software object accordingly.

A definition associated with a software object (e.g., names of attributes and semantics of the attributes) may be referred to as a “class definition.” A particular software object may be referred to as an “instance” of a particular class. For example, there may be a class definition for a switch. If there are one-hundred switches under management, there will be one-hundred instances (e.g., in the MIB) all using the same class definition.

Client-server, hierarchical architectures have several disadvantages. For example, when a client wants to change a value of an instance attribute, the client needs to provide a new value of the instance attribute to the server, via a modification request. The client is unable to provide to the server a portion of the attribute that needs to be changed, via the modification request. In one example, if an instance attribute includes a list of sub-attributes (e.g., sub-attribute-1, sub-attribute-2, etc.) and the client only wants to change a value of sub-attribute-2, the client needs to send to the server the entire instance attribute, such as sub-attribute-1 (old value), sub-attribute-2 (new value), sub-attribute-3 (old value), etc. The client is unable to send only the portion of the instance attribute requiring change (i.e., sub-attribute-2). Because the client needs to send the entire instance attribute that contains the modified sub-attribute and cannot just send the sub-attribute to be modified, modification of a large instance attribute may require a large amount of bandwidth.

Furthermore, when the server sends a notification to various clients about changes to an instance attribute, the server needs to send the entire instance attribute, even though only one sub-attribute (e.g., a portion of) of the instance attribute has changed. In such a notification, the server is unable to indicate only the changed sub-attribute. Rather, the notification includes the entire instance attribute (e.g., including all of the sub-attributes), and not just the sub-attribute that has changed. Accordingly, each client needs to compare the receive instance attribute, and all of its sub-attributes, to its current copy of the instance attribute, and all of its sub-attributes to determine the changed sub-attribute. Such a process may be inefficient, time-consuming, and use valuable network resources (e.g., processing resources, bandwidth resources, etc.).

### SUMMARY

It is an object of the invention to overcome at least some of the above disadvantages and to implement network management information (e.g., modification requests and notifications) so that a portion of an instance attribute may be modified (e.g., by a client), and so that notifications (e.g., provided by a server) may include the modified portion of the instance attribute.

Embodiments described herein may provide systems and/or methods that implement network management information (e.g., modification request and/or notifications). For example, in one embodiment, the systems and/or methods may include a client device (e.g., a device that provides a request to modify a portion of an instance attribute), and a server device (e.g., a device that stores, maintains, and/or provides instance attribute information and/or notifications to the client device). The server device may store the instance attribute information and the notifications in a database. The instance attribute information may include software object (or instance) attributes. An instance attribute may include a property that includes a value, and may be either a default value or a conditional value. Default initial values for instance attributes may be specified as part of a software object class definition. Attribute names and semantics for each class of software object may be specified by the software object class schema, and may be known to both the client device and the server device. The client device may provide (e.g., to server device) a request to modify a portion of an instance attribute, and the server device may modify the portion of the instance attribute in its database. The requested modification may include adding one or more sub-attributes to an instance attribute, deleting one or more sub-attributes from an instance attribute, modifying one or more sub-attributes from an instance attribute, and/or resetting default values of one or more sub-attributes associated with an instance attribute.

In another embodiment, because network nodes and functions represented by software objects may be dynamic (e.g., their state may change over time), values associated with instance attributes may change. The changes may be conveyed to the client device via notifications. A notification may include a message with a number of notification parameters. The types of notifications and the notification parameters may be specified by and/or known to both the client device and the server device. In one example, a notification may include information associated with a modified portion of instance attribute, rather than information associated with the entire instance attribute.

In an exemplary embodiment, systems and/or methods described herein may receive a request to modify a portion (e.g., a sub-attribute) of an instance attribute (e.g., a software object attribute), may identify an instance based on the request, and may identify an attribute of the instance based on the request. The systems and/or methods may identify a sub-attribute of the identified attribute based on the request, may identify a sub-attribute value based on the request, and may identify an operation based on the request. The systems and/or methods may perform the operation on the identified sub-attribute with the identified value to produce the modified portion of the instance attribute, and may provide a notification that includes the modified portion of the instance attribute.

Embodiments described herein may provide a variety of advantages. For example, because a portion (e.g., a sub-attribute) of an instance attribute may be modified via a modification request described herein, the modification request may be smaller in size. Thus, less bandwidth may be required to transfer the modification request, and the client may require less time and less processing cycles to construct the modification request. With the modification request, the client does not need to read the entire instance attribute into memory, modify the sub-attribute into memory, and request modification of the entire instance attribute. Rather, the client may generate a modification request describing the modified sub-attribute. The modification request may also reduce the chances of data corruption for multiple clients because the multiple clients may not need to maintain recent changes made by other clients. Instead, the multiple clients may modify sub-attribute(s) without taking into account changes made by other clients. Furthermore, a server may require less time to decode the modification request, and to make the modification to the portion of the instance attribute (e.g., provided in a MIB).

The server may broadcast the modified portion (e.g., a sub-attribute) of the instance attribute to other clients via a notification described herein. Thus, the notification may be smaller in size, less bandwidth may be required to transfer the notification, and the server may require less time and less processing cycles to construct the notification. The clients receiving the notification may require less time and less processing cycles to detect the modified portion of the instance attribute since they may receive (e.g., via the notification) the modified portion of the instance attribute and not the entire instance attribute.

### BRIEF DESCRIPTION OF THE DRAWINGS

FIG. 1 depicts a diagram of an exemplary network in which systems and/or methods described herein may be implemented;

FIG. 2 illustrates exemplary components of a client and/or a server of the network depicted in FIG. 1;

FIG. 3 depicts a diagram of an exemplary portion of the network illustrated in FIG. 1 and exemplary interactions among components of the network portion;

FIG. 4 illustrates a diagram of an exemplary portion of a database capable of being generated, stored, and/or maintained by the server of the network depicted in FIG. 1;

FIG. 5 depicts a diagram of exemplary components of modification requests capable of being generated by the client of the network illustrated in FIG. 1;

FIG. 6 illustrates a diagram of exemplary components of a notification capable of being generated by the server of the network depicted in FIG. 1; and

FIGS. 7-13 depict flow charts of exemplary processes for implementing modification requests and/or notifications according to embodiments described herein.

### DETAILED DESCRIPTION

The following detailed description refers to the accompanying drawings. The same reference numbers in different drawings may identify the same or similar elements. Also, the following detailed description does not limit the invention.

Embodiments described herein may provide systems and/or methods that implement modification requests and/or notifications based on instance attributes and/or notification parameters, respectively.

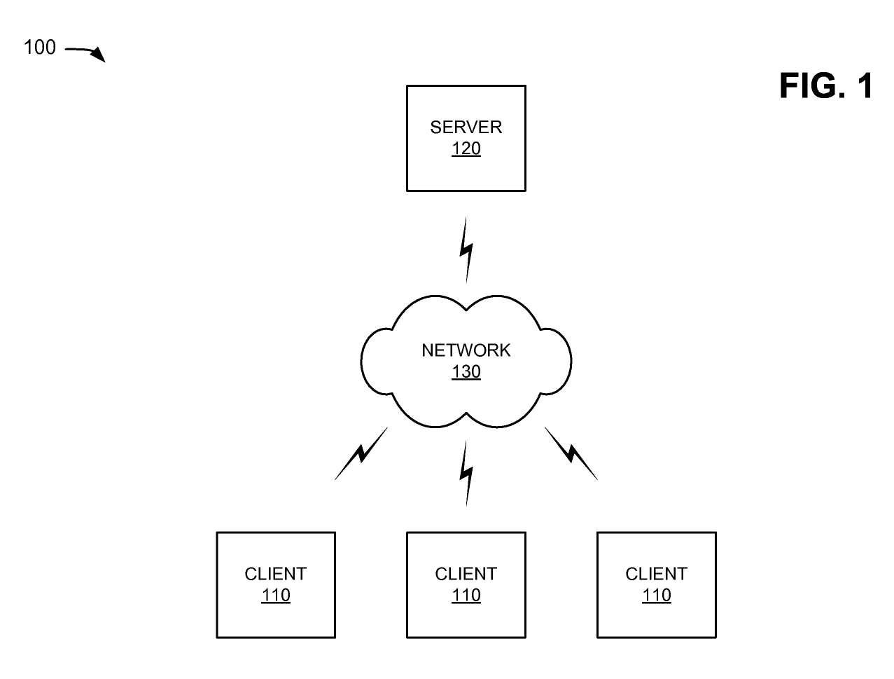

FIG. 1 depicts a diagram of an exemplary network 100 in which systems and/or methods described herein may be implemented. As illustrated, network 100 may include clients 110 and a server 120 interconnected by a network 130. Clients 110 and/or server 120 may connect to network 130 via wired and/or wireless connections. Three clients, a single server, and a single network have been illustrated in FIG. 1 for simplicity. In practice, there may be more clients, servers, and/or networks. Also, in some instances, a component in network 100 (e.g., one or more of clients 110 and/or server 120) may perform one or more functions described as being performed by another component or group of components in network 100. For example, in one embodiment, one of clients 110 may act as a server, and server 120 may act as a client.

Each of clients 110 may include any device capable of generating and/or receiving data (e.g., network management information (NMI)) associated with network 100. For example, each of clients 110 may include a computer, a router, a switch, a network interface card (NIC), a hub, a bridge, a gateway, a firewall, a proxy server, an optical add-drop multiplexer (OADM), a cell phone, some other type of device that processes and/or transfers data, another type of computation or communication device, a thread or process running on one of these devices, and/or an object executable by one of these devices. In one embodiment, each of clients 110 may include a node of a telecommunication network.

The term “data,” as used herein, is to be broadly construed to include any information capable of being generated by network 100 and/or any component of network 100 (e.g., clients 110 and/or server 120), such as information associated with the operation, administration, maintenance, provisioning, etc. of telecommunication systems, modification requests, notifications, etc.

Server 120 may include one or more server entities, or other types of computation or communication devices, that gather, process, search, and/or provide information (e.g., network management information (NMI)) in a manner described herein. For example, server 120 may include a computer, a router, a switch, a network interface card (NIC), a hub, a bridge, a gateway, a firewall, a proxy server, an optical add-drop multiplexer (OADM), some other type of device that processes and/or transfers data, another type of computation or communication device, a thread or process running on one of these devices, and/or an object executable by one of these devices. In one embodiment, server 120 may include a node of a telecommunication network.

Network 130 may include a local area network (LAN), a wide area network (WAN), a metropolitan area network (MAN), an intranet, the Internet, a Public Land Mobile Network (PLMN), a telephone network, such as the Public Switched Telephone Network (PSTN) or a cellular telephone network, or a combination of networks. In one exemplary embodiment, network 130 may include a telecommunication network.

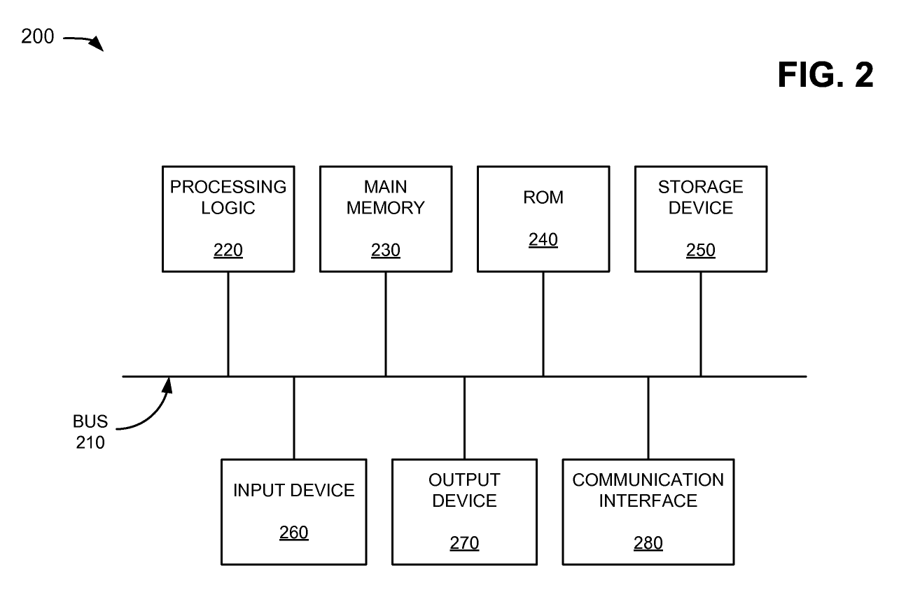

FIG. 2 is an exemplary diagram of a device 200 that may correspond to one of clients 110 and/or server 120. As illustrated, device 200 may include a bus 210, processing logic 220, a main memory 230, a read-only memory (ROM) 240, a storage device 250, an input device 260, an output device 270, and/or a communication interface 280. Bus 210 may include a path that permits communication among the components of device 200.

Processing logic 220 may include a processor, microprocessor, an application specific integrated circuit (ASIC), a field programmable gate array (FPGA), or other type of processing logic that may interpret and execute instructions. Main memory 230 may include a random access memory (RAM) or another type of dynamic storage device that may store information and instructions for execution by processing logic 220. ROM 240 may include a ROM device or another type of static storage device that may store static information and/or instructions for use by processing logic 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, etc. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network, such as network 150.

As described herein, device 200 may perform certain operations in response to processing logic 220 executing software instructions contained in a computer-readable medium, such as main memory 230. A computer-readable medium may be defined as one or more physical and/or logical memory devices. The software instructions may be read into main memory 230 from another computer-readable medium, such as storage device 250, or from another device via communication interface 280. The software instructions contained in main memory 230 may cause processing logic 220 to perform processes described herein. Alternatively, hardwired circuitry may be used in place of or in combination with software instructions to implement processes described herein. Thus, embodiments described herein are not limited to any specific combination of hardware circuitry and software.

Although FIG. 2 shows exemplary components of device 200, in other embodiments, device 200 may contain fewer, different, or additional components than depicted in FIG. 2. In still other embodiments, one or more components of device 200 may perform one or more other tasks described as being performed by one or more other components of device 200.

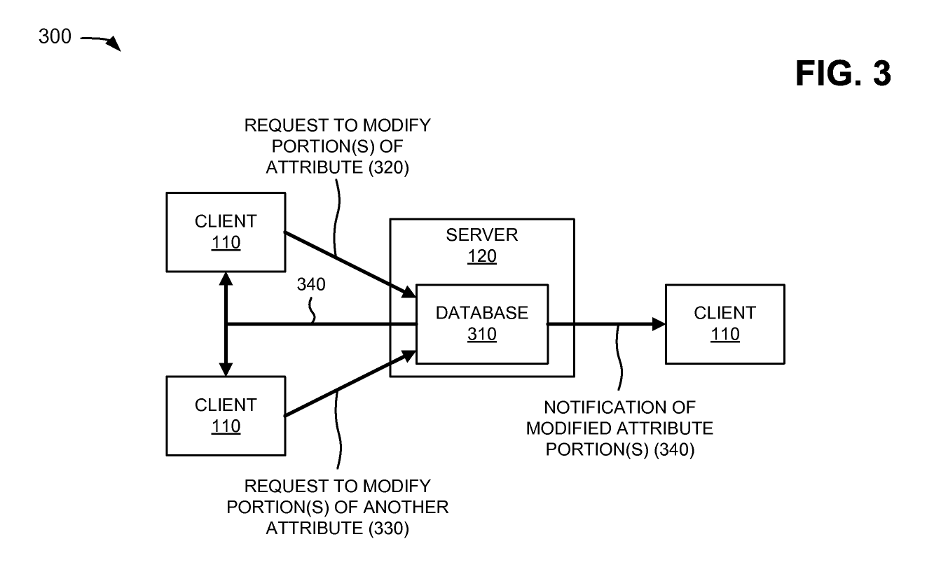

FIG. 3 depicts a diagram of an exemplary portion 300 of network 100 and exemplary interactions among components of network portion 300. As illustrated, network portion 300 may include clients 110 and server 120. Clients 110 and server 120 may include the features described above in connection with, for example, FIG. 1.

Server 120 may store information, such as software objects (or instances), software object information, instance attributes, notifications, etc., in a database 310. In one embodiment, database 310 may be generated, stored, and/or maintained by server 120 (e.g., within memory 220). In another embodiment, database 310 may be generated, stored, and/or maintained by a device other than or in addition to server 120. In one example, database 310 may correspond to a Management Information Base (MIB).

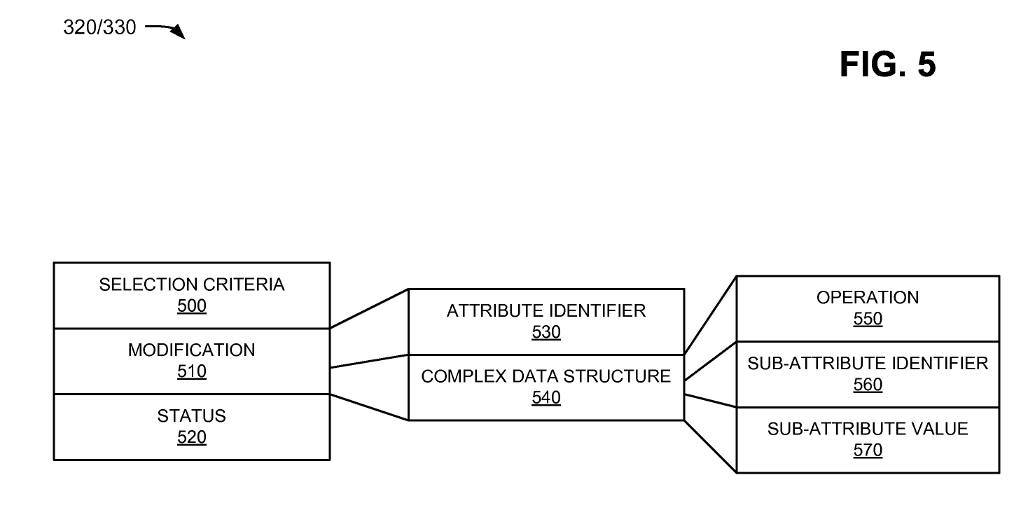

As shown in FIG. 3, clients 110 may provide modification requests to database 310. For example, one client 110 may provide a request 320 to modify one or more portions of an instance attribute to database 310, and another client 110 may provide a request 330 to modify one or more portions of another instance attribute to database 310. Other software object information may be provided to database 310 via other devices (not shown) associated with a network (e.g., network 130). Modification requests 320/330 may include information associated with an instance attribute to be modified, one or more portions (e.g., sub-attributes) to be modified, an operation to be performed on the one or more portions, etc. The operation to be performed may include adding new sub-attribute(s) to the instance attribute, deleting sub-attribute(s) from the instance attribute, deleting all sub-attributes associated with the instance attribute, resetting sub-attribute(s) associated with the instance attribute to default value(s), and/or modifying value(s) of sub-attribute(s) associated with the instance attribute. Further details of modification requests 320/330 are provided below in connection with, for example, FIG. 5.

Server 120 may receive each of modification requests 320/330 from clients 110, and may identify an instance (e.g., an instance with one or more attribute portions to be modified) based on each of modification requests 320/330. For example, server 120 may identify an instance provided in database 310 based on modification requests 320/330. Server 120 may further identify an instance attribute, a sub-attribute of the instance attribute, a value associated with the sub-attribute, and an operation (e.g., to be performed on the sub-attribute) based on modification requests 320/330. Server 120 may execute the operation, with the value, on the identified sub-attribute to produce a modified portion (e.g., a sub-attribute) of the instance attribute.

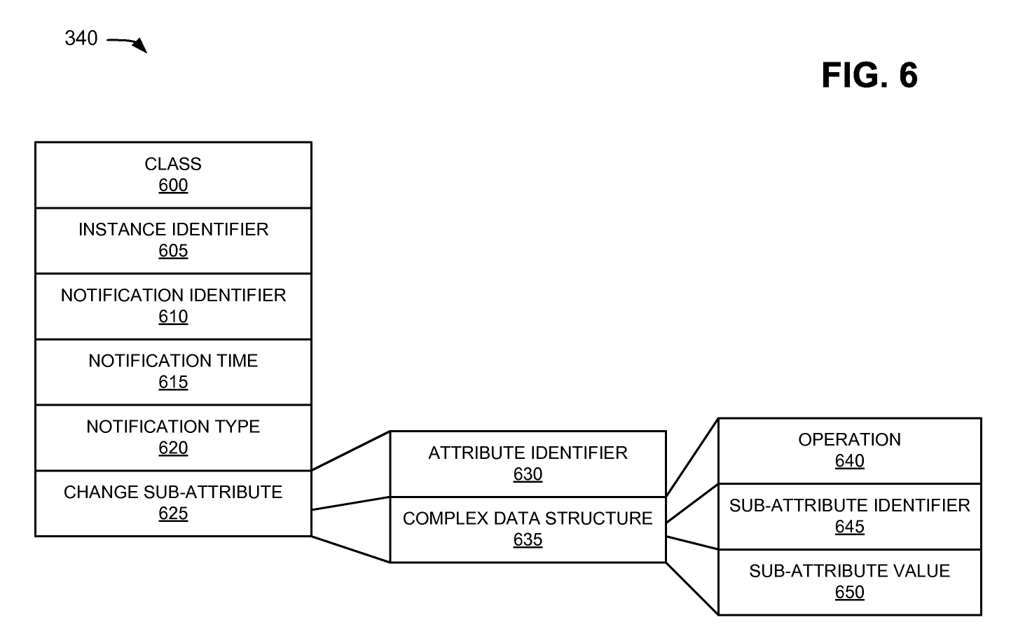

As further shown in FIG. 3, server 120 (e.g., via database 310) may provide, to clients 110, a notification 340 of one or more modified portions of an instance attribute. In one embodiment, notification 340 may provide an indication of changes to one or more sub-attributes of an instance (e.g., a software object) provided in database 310. Notification 340 may indicate that new sub-attribute(s) have been added to the instance attribute, that sub-attribute(s) have been deleted from the instance attribute, that all sub-attributes associated with the instance attribute have been deleted, that sub-attribute(s) associated with the instance attribute have been reset to default value(s), and/or that value(s) of sub-attribute(s) associated with the instance attribute have been modified. For example, notification 340 may include information associated with a class of a modified instance attribute, the modified instance associated with the modified instance attribute, a notification identifier, time, and/or type, the modified instance attribute, one or more modified portions (e.g., sub-attributes) of the modified instance attribute, an operation performed on the one or more modified portions, etc. Further details of notification 340 are provided below in connection with, for example, FIG. 6.

Unlike current telecommunication system management schemes, the clients (e.g., clients 110) described herein may generate a modification request (e.g., modification requests 320/330) requesting that a portion (e.g., a sub-attribute) of an instance attribute be modified. Furthermore, unlike current telecommunication system management schemes, the server (e.g., server 120) described herein may generate a notification (e.g., notification 340) that provides an indication of modifications to one or more portions (e.g., sub-attributes) of an instance attribute.

Although FIG. 3 shows exemplary components of network portion 300, in other embodiments, network portion 300 may contain fewer, different, or additional components than depicted in FIG. 3. In still other embodiments, one or more components of network portion 300 may perform one or more other tasks described as being performed by one or more other components of network portion 300.

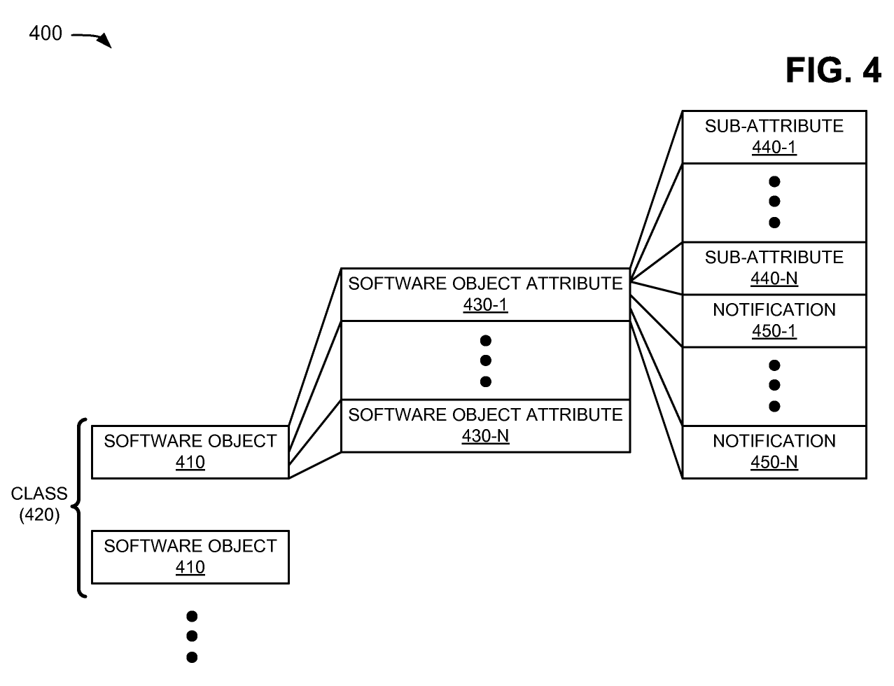

FIG. 4 illustrates a diagram of an exemplary portion 400 of database 310. As illustrated in FIG. 4, database portion 400 may include one or more software object fields 410 (or instances) associated with a class 420. Each software object field 410 may include one or more software object (or instance) attributes 430-1, . . . , 430-N (collectively referred to as “software object attributes 430,” and individually as “software object attribute 430”). Each software object attribute 430 may include one or more sub-attributes 440-1, . . . , 440-N (collectively referred to as “sub-attributes 440,” and individually as “sub-attribute 440”), and/or one or more notifications 450-1, . . . , 450-N (collectively referred to as “notifications 450,” and individually as “notification 450”). Although not shown in FIG. 4, database portion 400 may include other software object classes and/or information.

Software object field 410 may include a representation of a managed resource (e.g., a network node under management, a network function under management, a network communication link under management, etc.). In telecommunication system management, software object field 410 may include a collection of attributes associated with a managed resource, such as its Distinguished Name (e.g., a unique name for an entry in a Directory Service), its operational state, its alarm state, its number of partner node connections, etc.

Class 420 may define characteristics of a type of physical or logical resource. For example, in one embodiment, instances of class 420 may exist to represent specific instances of a resource. Therefore, software objects (e.g., software object fields 410) and/or software object attributes 430 may be instances of class 420.

Software object attributes 430 may include properties of a software object (e.g., software object field 410) that include values. Default initial values for software object attributes 430 may be specified as part of a software object class definition. In one embodiment, for example, software object attributes 430 may include attribute names and/or semantics. Attribute names and semantics for each class of software object may be specified by the software object class schema.

Sub-attributes 440 may include properties of instance attribute (e.g., software object attribute 430) that include values. In one embodiment, for example, sub-attributes 440 may include sub-attribute names and/or semantics. Sub-attribute names and semantics for each instance attribute may be specified by the software object class schema.

Notifications 450 may include information associated with notifications (e.g., notification 340). For example, notifications 450 may include information indicating changes to portions (e.g., sub-attributes 440) of instance attributes (e.g., software object attributes 430) upon occurrence of events, such as changes to values associated with sub-attributes 440. In one embodiment, notifications 450 may include information that identifies types of notifications associated with sub-attributes 440, one or more notification parameters, etc.

In one exemplary embodiment, the some of information contained in database portion 400 may be provided to server 120 by clients 110 (e.g., via modification requests 320/330). In another exemplary embodiment, some of the information contained in database portion 400 may be provided to clients 110 by server 120 (e.g., via notification 340).

Although FIG. 4 shows exemplary elements of database portion 400, in other embodiments, database portion 400 may contain fewer, different, or additional elements than depicted in FIG. 4.

FIG. 5 depicts a diagram of exemplary components of modification request 320 and/or modification request 330. In one embodiment, modification requests 320/330 may be generated by clients 110. In another embodiment, modification requests may be generated by a device (e.g., server 120) other than or in addition to clients 110. As illustrated, modification requests 320/330 may include a selection criteria parameter 500, a modification parameter 510, and a status parameter 520. Modification parameter 510 may include an attribute identifier element 530 and a complex data structure element 540. Complex data structure element 540 may include an operation element 550, a sub-attribute identifier element 560, and a sub-attribute value element 570.

Selection criteria parameter 500 may include information that allows a set of instances (e.g., software objects) to be selected from database 310. For example, in one embodiment, selection criteria parameter 500 may include information that allows one or more software object fields 410 provided in database portion 400 to be selected, as described above in connection with FIG. 4. In an exemplary embodiment, selection criteria parameter 500 may include a parameter (e.g., “instanceSelectionCriteria”) that provides selection criteria for selecting a set of instances from database 310.

Modification parameter 510 may include information that allows one or more portions (e.g., sub-attributes 440) of an instance attribute (e.g., software object attribute 430) to be modified. For example, in one embodiment, modification parameter 510 may include attribute identifier element 530 and complex data structure element 540. In an exemplary embodiment, modification parameter 510 may include a parameter (e.g., “modificationList”) that provides information used to modify one or more portions (e.g., sub-attributes 440) of an instance attribute (e.g., software object attribute 430).

Status parameter 520 may include information that may return status regarding modification requests 320/330. For example, in one embodiment, status parameter 520 may return information indicating that modification requests 320/330 were successful or unsuccessfully executed. In an exemplary embodiment, status parameter 520 may include an output parameter (e.g., “status”) that provides status information associated with modification requests 320/330.

Attribute identifier element 530 may include information identifying an instance attribute (e.g., software object attribute 430) whose sub-attribute (e.g., sub-attribute 440) is to be modified. In an exemplary embodiment, attribute identifier element 530 may include an element (e.g., “{attribute identifier}”) that identifies an instance attribute (e.g., software object attribute 430) whose sub-attribute (e.g., sub-attribute 440) is to be modified.

Complex data structure element 540 may include information identifying an operation to be performed on a sub-attribute to be modified, information identifying the sub-attribute to be modified, and information associated with a value to be used by the operation to be performed on the sub-attribute to be modified. In an exemplary embodiment, complex data structure element 540 may include an element (e.g., “{sb-container}”) that provides an operation to be performed on a sub-attribute (e.g., sub-attribute 440) to be modified, the sub-attribute to be modified, and a value to be used by the operation to be performed on the sub-attribute to be modified.

Operation element 550 may include information identifying an operation to be performed on a sub-attribute (e.g., sub-attribute 440) to be modified. For example, in one embodiment, the operation may include an “insert” operation (e.g., an operation that adds a new sub-attribute to an identified instance attribute (e.g., identified by attribute identifier element 530)), a “delete” operation (e.g., an operation that removes an identified sub-attribute (e.g., identified by sub-attribute identifier element 560) from the identified instance attribute), a “delete-all” operation (e.g., an operation that removes all sub-attributes from the identified instance attribute), and/or a “modify” operation (e.g., an operation that replaces a current value of the identified sub-attribute with a new value). In an exemplary embodiment, operation element 550 may include an element (e.g., “{operation}”) that provides an operation (e.g., an insert operation, a delete operation, a delete-all operation, and/or a modify operation) to be performed on a sub-attribute (e.g., sub-attribute 440) to be modified.

Sub-attribute identifier element 560 may include information identifying a sub-attribute (e.g., sub-attribute 440) to be modified. For example, in one embodiment, if the identified instance attribute includes a name-value pair associated with the sub-attribute, sub-attribute identifier element 560 may include a name of the name-value pair of the sub-attribute (e.g., sub-attribute 440) to be modified. In an exemplary embodiment, sub-attribute identifier element 560 may include an element (e.g., “{sb-identifier}”) that provides an identifier of a sub-attribute (e.g., sub-attribute 440) whose value was modified.

Sub-attribute value element 570 may include information identifying a value to be used by the operation (e.g., identified by operation element 550) to be performed on a sub-attribute (e.g., sub-attribute 440) to be modified. If sub-attribute value element 570 does not contain a value, a default value may be set for the sub-attribute (e.g., sub-attribute 440) to be modified. In an exemplary embodiment, sub-attribute value element 570 may include an element (e.g., “{sb-value}”) that provides a value to be used in an operation to be performed on a sub-attribute (e.g., sub-attribute 440) to be modified.

Although FIG. 5 shows exemplary components of modification requests 320/330, in other embodiments, modification requests 320/330 may contain fewer, different, or additional components than depicted in FIG. 5.

FIG. 6 illustrates a diagram of exemplary components of notification 340. In one embodiment, notification 340 may be generated by a server (e.g., server 120). In another embodiment, notification 340 may be generated by a device other than or in addition to server 120. As illustrated, notification 340 may include a class parameter 600, an instance identifier parameter 605, a notification identifier parameter 610, a notification time parameter 615, a notification type parameter 620, and a change sub-attribute parameter 625. Change sub-attribute parameter 625 may include an attribute identifier element 630 and a complex data structure element 635. Complex data structure element 635 may include an operation element 640, a sub-attribute identifier element 645, and a sub-attribute value element 650.

Class parameter 600 may include information that identifies a class of an instance attribute (e.g., software object attribute 430) whose sub-attribute (e.g., sub-attribute 440) was modified. In an exemplary embodiment, class parameter 600 may include a parameter (e.g., “objectClass”) that identifies a class of an instance attribute (e.g., software object attribute 430) whose sub-attribute (e.g., sub-attribute 440) was modified.

Instance identifier parameter 605 may include information identifying an instance (e.g., software object 410) whose sub-attribute (e.g., sub-attribute 440) was modified. In an exemplary embodiment, instance identifier parameter 605 may include a parameter (e.g., “objectInstance”) that identifies an instance (e.g., software object 410) whose sub-attribute (e.g., sub-attribute 440) was modified.

Notification identifier parameter 610 may include information identifying a notification (e.g., notification 340). In an exemplary embodiment, notification identifier parameter 610 may include a parameter (e.g., “notificationId”) that identifies a particular notification (e.g., notification 340).

Notification time parameter 615 may include information associated with a time of a notification (e.g., notification 340), such as a time when a notification is generated and/or sent by server 120. In an exemplary embodiment, notification time parameter 615 may include a parameter (e.g., “eventTime”) that identifies a time associated with notification 340.

Notification type parameter 620 may include information associated with a type of a notification (e.g., notification 340). For example, in one embodiment, notification type parameter 620 may indicate that notification 340 is a type set forth by change sub-attribute parameter 625. In an exemplary embodiment, notification type parameter 620 may include a parameter (e.g., “notificationType”) that identifies a type (e.g., successful or unsuccessful) associated with notification 340.

Change sub-attribute parameter 625 may include information that identifies one or more portions (e.g., sub-attributes 440) of an instance attribute (e.g., software object attribute 430) that were modified. For example, in one embodiment, change sub-attribute parameter 625 may include attribute identifier element 630 and complex data structure element 635. In an exemplary embodiment, change sub-attribute parameter 625 may include a parameter (e.g., “subAttributeValueChange”) that provides information that identifies one or more portions (e.g., sub-attributes 440) of an instance attribute (e.g., software object attribute 430) that were modified.

Attribute identifier element 630 may include information identifying an instance attribute (e.g., software object attribute 430) whose sub-attribute (e.g., sub-attribute 440) was modified. In an exemplary embodiment, attribute identifier element 630 may include an element (e.g., “{attribute identifier}”) that identifies an instance attribute (e.g., software object attribute 430) whose sub-attribute (e.g., sub-attribute 440) was modified.

Complex data structure element 635 may include information identifying an operation performed on a modified sub-attribute, information identifying the modified sub-attribute, and information associated with a value to be used by the operation performed on the modified sub-attribute. In an exemplary embodiment, complex data structure element 635 may include an element (e.g., “{sb-container}”) that provides an operation performed on a modified sub-attribute (e.g., sub-attribute 440), the modified sub-attribute, and a value used by the operation performed on the modified sub-attribute.

Operation element 640 may include information identifying an operation performed on a modified sub-attribute (e.g., sub-attribute 440). For example, in one embodiment, the operation may include an “insert” operation (e.g., an operation that adds a new sub-attribute to an identified instance attribute (e.g., identified by attribute identifier element 630)), a “delete” operation (e.g., an operation that removes an identified sub-attribute (e.g., identified by sub-attribute identifier element 645) from the identified instance attribute), a “delete-all” operation (e.g., an operation that removes all sub-attributes from the identified instance attribute), and/or a “modify” operation (e.g., an operation that replaces a current value of the identified sub-attribute with a new value). In an exemplary embodiment, operation element 640 may include an element (e.g., “{operation}”) that provides an operation (e.g., an insert operation, a delete operation, a delete-all operation, and/or a modify operation) performed on a modified sub-attribute (e.g., sub-attribute 440).

Sub-attribute identifier element 645 may include information identifying a modified sub-attribute (e.g., sub-attribute 440). For example, in one embodiment, if the identified instance attribute includes a name-value pair associated with the sub-attribute, sub-attribute identifier element 645 may include a name of the name-value pair of the modified sub-attribute (e.g., sub-attribute 440). In an exemplary embodiment, sub-attribute identifier element 645 may include an element (e.g., “{sb-identifier}”) that provides an identifier of a sub-attribute (e.g., sub-attribute 440) whose value was modified.

Sub-attribute value element 650 may include information identifying a value used in the operation (e.g., identified by operation element 640) performed on a modified sub-attribute (e.g., sub-attribute 440). In an exemplary embodiment, sub-attribute value element 650 may include an element (e.g., “{sb-value}”) that provides a value used in an operation performed on a modified sub-attribute (e.g., sub-attribute 440).

Although FIG. 6 shows exemplary components of notification 340, in other embodiments, notification 340 may contain fewer, different, or additional components than depicted in FIG. 6.

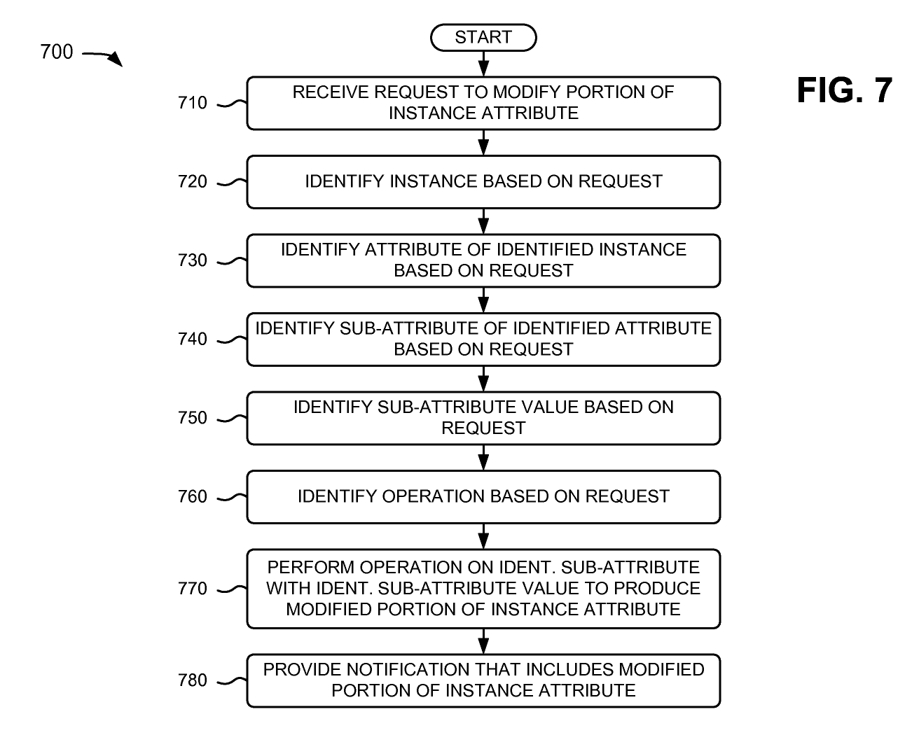

FIGS. 7-10 depict flow charts of an exemplary process 700 for implementing modification requests and/or notifications according to embodiments described herein. In one embodiment, process 700 may be performed by hardware and/or software components of server 120. In other embodiments, process 700 may be performed by hardware and/or software components of server 120 in combination with hardware and/or software components of another device or group of devices (e.g., communicating with server 120).

As illustrated in FIG. 7, process 700 may begin with receipt of a request to modify a portion of an instance attribute (block 710), identification of an instance based on the request (block 720), and identification of an attribute of the instance based on the request (block 730). For example, in embodiments described above in connection with FIG. 3, server 120 may receive modification requests 320/330 from clients 110, and may identify an instance (e.g., an instance with one or more attribute portions to be modified) based on modification requests 320/330. In one example, server 120 may identify an instance provided in database 310 based on modification requests 320/330.

Returning to FIG. 7, a sub-attribute of the identified attribute may be identified based on the request (block 740), a sub-attribute value may be identified based on the request (block 750), and an operation may be identified based on the request (block 760). For example, in embodiments described above in connection with FIG. 3, server 120 may identify an instance attribute, a sub-attribute of the instance attribute, a value associated with the sub-attribute, and an operation (e.g., to be performed on the sub-attribute) based on modification requests 320/330.

As further shown in FIG. 7, the operation may be performed on the identified sub-attribute with the identified sub-attribute value to produce the modified portion of the instance attribute (block 770), and a notification may be provided that includes the modified portion of the instance attribute (block 780). For example, in embodiments described above in connection with FIG. 3, server 120 may execute the operation, with the sub-attribute value, on the identified sub-attribute to produce a modified portion (e.g., a sub-attribute) of the instance attribute. Server 120 (e.g., via database 310) may provide, to clients 110, notification 340 of one or more modified portions of an instance attribute. In one example, notification 340 may provide an indication of changes to one or more sub-attributes of an instance (e.g., a software object) provided in database 310. Notification 340 may indicate that new sub-attribute(s) have been added to the instance attribute, that sub-attribute(s) have been deleted from the instance attribute, that all sub-attributes associated with the instance attribute have been deleted, that sub-attribute(s) associated with the instance attribute have been reset to default value(s), and/or that value(s) of sub-attribute(s) associated with the instance attribute have been modified.

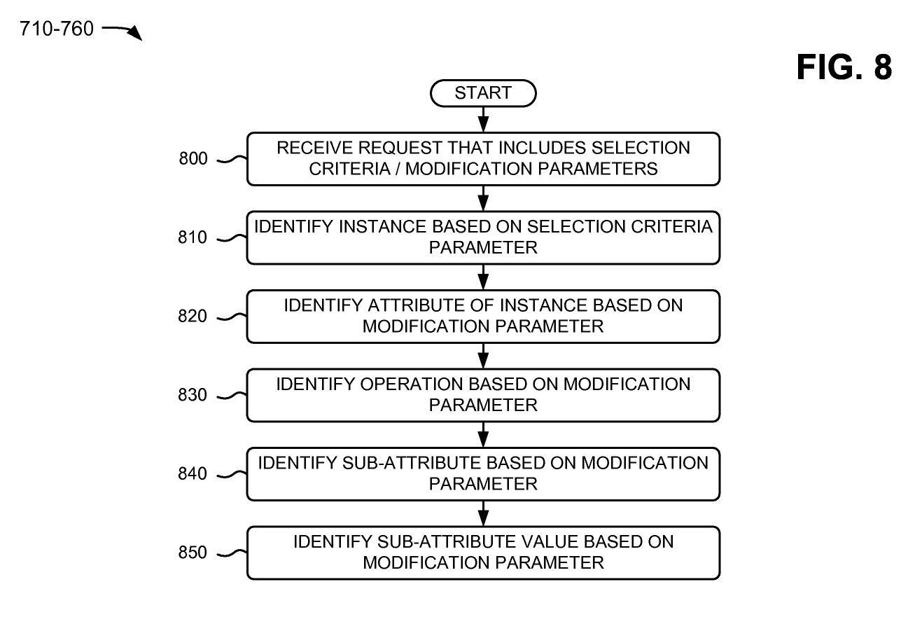

Process blocks 710-760 may include the process blocks depicted in FIG. 8. As illustrated in FIG. 8, process blocks 710-760 may include receiving a request that includes a selection criteria parameter and/or a modification parameter (block 800), identifying the instance based on the selection criteria parameter (block 810), and identifying the attribute of the instance based on the modification parameter (block 820). For example, in embodiments described above in connection with FIG. 5, server 120 may receive modification requests 320/330 that may include selection criteria parameter 500 and modification parameter 510. Modification parameter 510 may include attribute identifier element 530 and complex data structure element 540. Complex data structure element 540 may include operation element 550, sub-attribute identifier element 560, and sub-attribute value element 570. Selection criteria parameter 500 may include a parameter (e.g., “instanceSelectionCriteria”) that provides selection criteria for selecting a set of instances from database 310. Modification parameter 510 may include a parameter (e.g., “modificationList”) that provides information used to modify one or more portions (e.g., sub-attributes 440) of an instance attribute (e.g., software object attribute 430). Attribute identifier element 530 may include an element (e.g., “{attribute identifier}”) that identifies an instance attribute (e.g., software object attribute 430) whose sub-attribute (e.g., sub-attribute 440) was modified.

As further shown in FIG. 8, process blocks 710-760 may include identifying the operation based on the modification parameter (block 830), identifying the sub-attribute of the instance based on the modification parameter (block 840), and identifying the sub-attribute value based on the modification parameter (block 850). For example, in embodiments described above in connection with FIG. 5, complex data structure element 540 may include an element (e.g., “{sb-container}”) that provides an operation to be performed on a sub-attribute (e.g., sub-attribute 440) to be modified, the sub-attribute to be modified, and a value to be used by the operation to be performed on the sub-attribute to be modified. Operation element 550 may include an element (e.g., “{operation}”) that provides an operation (e.g., an insert operation, a delete operation, a delete-all operation, and/or a modify operation) to be performed on a sub-attribute (e.g., sub-attribute 440) to be modified. Sub-attribute identifier element 560 may include an element (e.g., “{sb-identifier}”) that provides an identifier of a sub-attribute (e.g., sub-attribute 440) whose value was modified. Sub-attribute value element 570 may include an element (e.g., “{sb-value}”) that provides a value to be used in an operation to be performed on a sub-attribute (e.g., sub-attribute 440) to be modified.

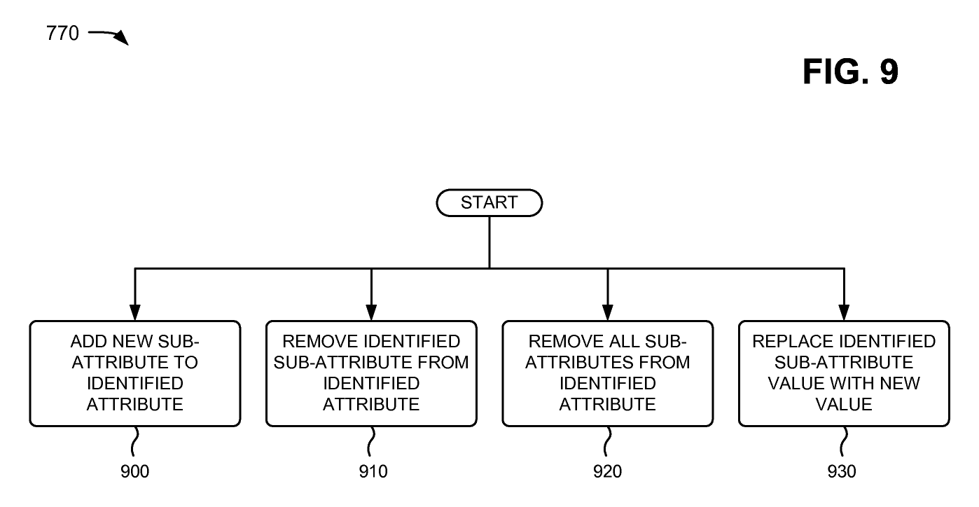

Process block 770 may include the process blocks depicted in FIG. 9. As illustrated in FIG. 9, process block 770 may include adding a new sub-attribute to the identified attribute (block 900), removing the identified sub-attribute from the identified attribute (block 910), removing all sub-attributes from the identified attribute (block 920), or replacing the identified sub-attribute value with a new value (block 930). For example, in embodiments described above in connection with FIG. 5, operation element 550 may include information identifying an operation to be performed on a sub-attribute (e.g., sub-attribute 440) to be modified. In one example, the operation may include an “insert” operation (e.g., an operation that adds a new sub-attribute to an identified instance attribute (e.g., identified by attribute identifier element 530)), a “delete” operation (e.g., an operation that removes an identified sub-attribute (e.g., identified by sub-attribute identifier element 560) from the identified instance attribute), a “delete-all” operation (e.g., an operation that removes all sub-attributes from the identified instance attribute), and/or a “modify” operation (e.g., an operation that replaces a current value of the identified sub-attribute with a new value).

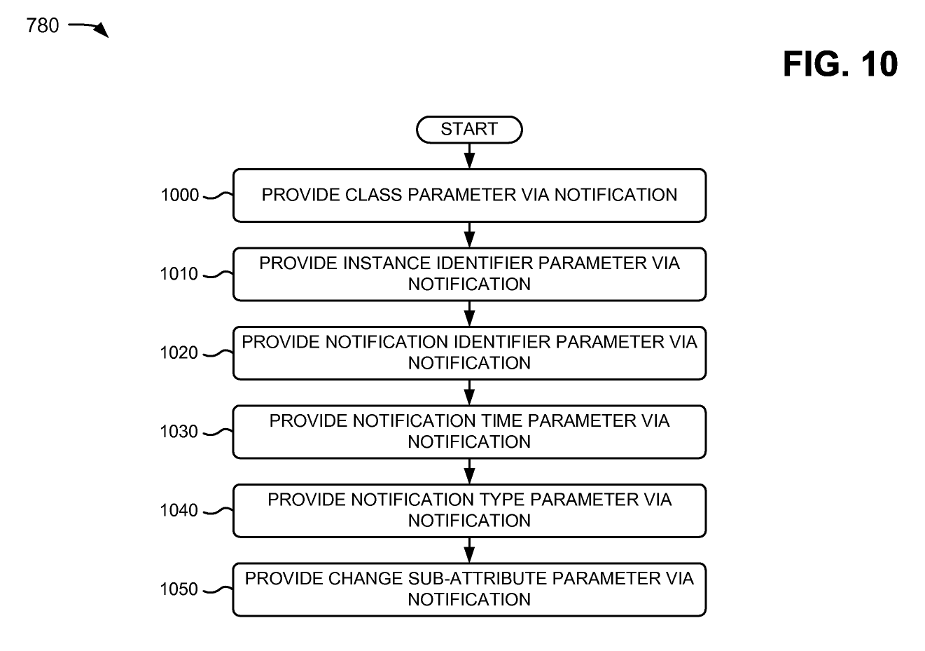

Process block 780 may include the process blocks depicted in FIG. 10. As illustrated in FIG. 10, process block 780 may include providing a class parameter via the notification (block 1000), providing an instance identifier parameter via the notification (block 1010), and providing a notification identifier parameter via the notification (block 1020). For example, in embodiments described above in connection with FIG. 6, server 120 may generate notification 340 that may include class parameter 600, instance identifier parameter 605, and notification identifier parameter 610. Class parameter 600 may include a parameter (e.g., “objectClass”) that identifies a class of an instance attribute (e.g., software object attribute 430) whose sub-attribute (e.g., sub-attribute 440) was modified. Instance identifier parameter 605 may include a parameter (e.g., “objectInstance”) that identifies an instance (e.g., software object 410) whose sub-attribute (e.g., sub-attribute 440) was modified. Notification identifier parameter 610 may include a parameter (e.g., “notificationId”) that identifies notification 340.

As further shown in FIG. 10, process block 780 may include providing a notification time parameter via the notification (block 1030), providing a notification type parameter via the notification (block 1040), and providing a change sub-attribute parameter via the notification (block 1050). For example, in embodiments described above in connection with FIG. 6, generated notification 340 may include notification time parameter 615, notification type parameter 620, and change sub-attribute parameter 625. Notification time parameter 615 may include a parameter (e.g., “eventtime”) that identifies a time associated with notification 340. Notification type parameter 620 may include a parameter (e.g., “notificationType”) that identifies a type associated with notification 340. Change sub-attribute parameter 625 may include a parameter (e.g., “subAttributeValueChange”) that provides information about one or more modified portions (e.g., sub-attributes 440) of an instance attribute (e.g., software object attribute 430).

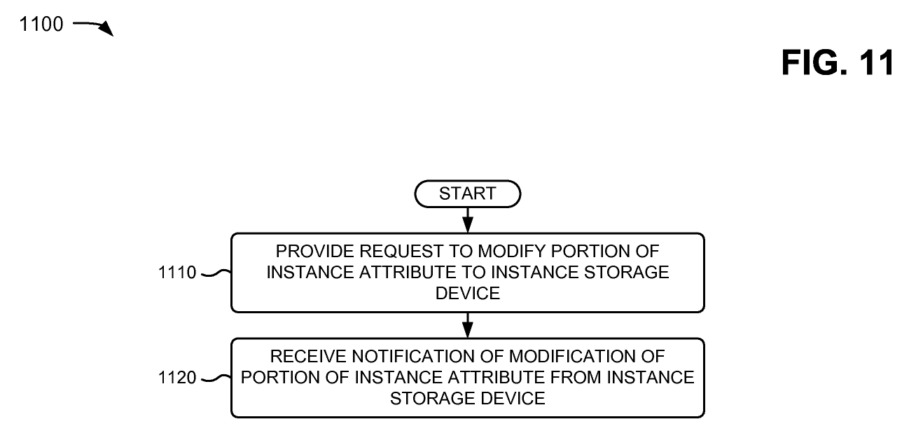

FIGS. 11-13 depict flow charts of an exemplary process 1100 for implementing modification requests and/or notifications according to embodiments described herein. In one embodiment, process 1100 may be performed by hardware and/or software components of client 110. In other embodiments, process 1100 may be performed by hardware and/or software components of client 110 in combination with hardware and/or software components of another device or group of devices (e.g., communicating with client 110).

As illustrated in FIG. 11, process 1100 may include providing a request to modify a portion of an instance attribute to an instance storage device (block 1110), and receiving, from the instance storage device, a notification of modification of the portion of the instance attribute (block 1120). For example, in embodiments described above in connection with FIG. 3, clients 110 may provide modification requests 320/330 to server 120. Server 120 may receive modification requests 320/330 from clients 110, and may identify an instance (e.g., an instance with one or more attribute portions to be modified) based on modification requests 320/330. In one example, server 120 may identify an instance attribute, a sub-attribute of the instance attribute, a value associated with the sub-attribute, and an operation (e.g., to be performed on the sub-attribute) based on modification requests 320/330. Server 120 may execute the operation, with the value, on the identified sub-attribute to produce a modified portion (e.g., a sub-attribute) of the instance attribute. Server 120 (e.g., via database 310) may provide, and clients 110 may receive, notification 340 of one or more modified portions of an instance attribute. In one example, notification 340 may provide an indication of changes to one or more sub-attributes of an instance (e.g., a software object) provided in database 310.

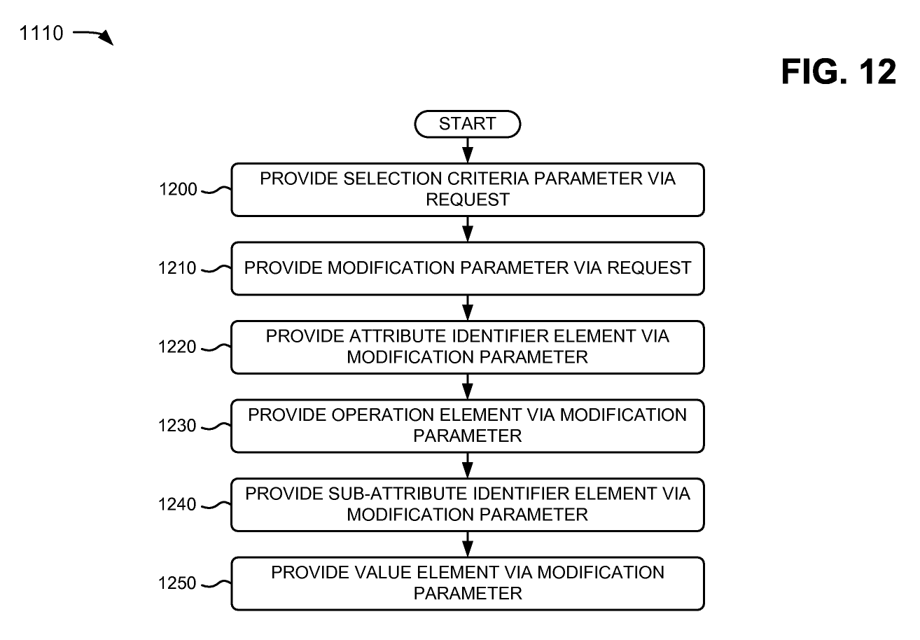

Process block 1110 may include the process blocks depicted in FIG. 12. As illustrated in FIG. 12, process block 1110 may include providing a selection criteria parameter via the request (block 1200), providing a modification parameter via the request (block 1210), and providing an attribute modifier element via the modification parameter (block 1220). For example, in embodiments described above in connection with FIG. 5, clients 110 may provide modification requests 320/330 that may include selection criteria parameter 500, modification parameter 510, and status parameter 520. Modification parameter 510 may include attribute identifier element 530 and complex data structure element 540. Complex data structure element 540 may include operation element 550, sub-attribute identifier element 560, and sub-attribute value element 570. Selection criteria parameter 500 may include a parameter (e.g., “instanceSelectionCriteria”) that provides selection criteria for selecting a set of instances from database 310. Modification parameter 510 may include a parameter (e.g., “modificationList”) that provides information used to modify one or more portions (e.g., sub-attributes 440) of an instance attribute (e.g., software object attribute 430). Attribute identifier element 530 may include an element (e.g., “{attribute identifier}”) that identifies an instance attribute (e.g., software object attribute 430) whose sub-attribute (e.g., sub-attribute 440) was modified.

As further shown in FIG. 12, process block 1110 may include providing an operation element via the modification parameter (block 1230), providing a sub-attribute identifier element via the modification parameter (block 1240), and providing a value element via the modification parameter (block 1250). For example, in embodiments described above in connection with FIG. 5, complex data structure element 540 may include an element (e.g., “{sb-container}”) that provides an operation to be performed on a sub-attribute (e.g., sub-attribute 440) to be modified, the sub-attribute to be modified, and a value to be used by the operation to be performed on the sub-attribute to be modified. Operation element 550 may include an element (e.g., “{operation}”) that provides an operation (e.g., an insert operation, a delete operation, a delete-all operation, and/or a modify operation) to be performed on a sub-attribute (e.g., sub-attribute 440) to be modified. Sub-attribute identifier element 560 may include an element (e.g., “{sb-identifier}”) that provides an identifier of a sub-attribute (e.g., sub-attribute 440) whose value was modified. Sub-attribute value element 570 may include an element (e.g., “{sb-value}”) that provides a value to be used in an operation to be performed on a sub-attribute (e.g., sub-attribute 440) to be modified.

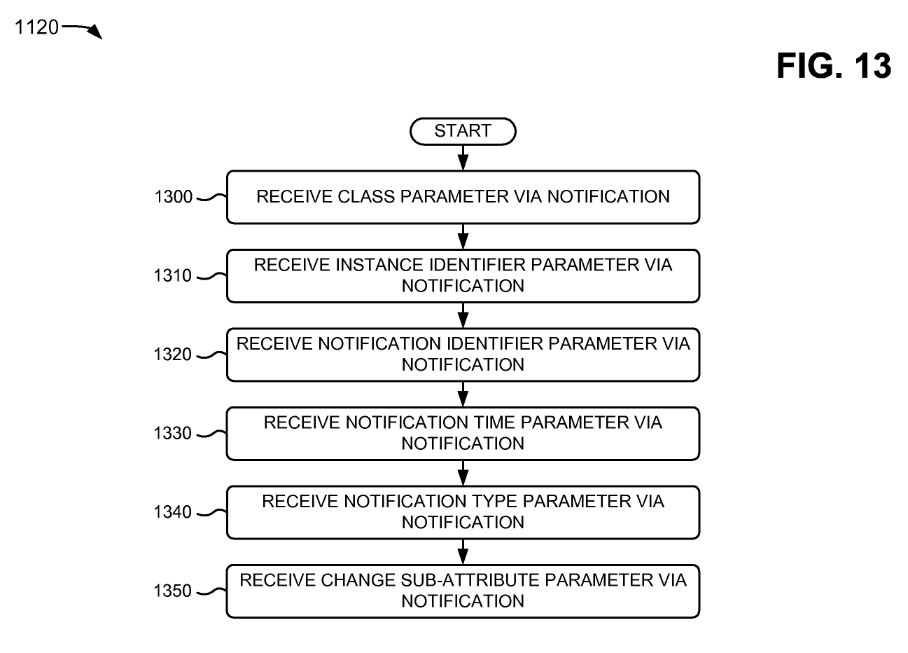

Process block 1120 may include the process blocks depicted in FIG. 13. As illustrated in FIG. 13, process block 1120 may include receiving a class parameter via the notification (block 1300), receiving an instance identifier parameter via the notification (block 1310), and receiving a notification identifier parameter via the notification (block 1320). For example, in embodiments described above in connection with FIG. 6, clients 110 may receive notification 340 that may include class parameter 600, instance identifier parameter 605, and notification identifier parameter 610. Class parameter 600 may include a parameter (e.g., “objectClass”) that identifies a class of an instance attribute (e.g., software object attribute 430) whose sub-attribute (e.g., sub-attribute 440) was modified. Instance identifier parameter 605 may include a parameter (e.g., “objectInstance”) that identifies an instance (e.g., software object 410) whose sub-attribute (e.g., sub-attribute 440) was modified. Notification identifier parameter 610 may include a parameter (e.g., “notificationId”) that identifies notification 340.

Returning to FIG. 13, process block 1120 may include receiving a notification time parameter via the notification (block 1330), receiving a notification type parameter via the notification (block 1340), and receiving a change sub-attribute parameter via the notification (block 1350). For example, in embodiments described above in connection with FIG. 6, notification 340 may further include notification time parameter 615, notification type parameter 620, and change sub-attribute parameter 625. Notification time parameter 615 may include a parameter (e.g., “eventTime”) that identifies a time associated with notification 340. Notification type parameter 620 may include a parameter (e.g., “notificationType”) that identifies a type associated with notification 340. Change sub-attribute parameter 625 may include a parameter (e.g., “subAttributeValueChange”) that provides information about one or more modified portions (e.g., sub-attributes 440) of an instance attribute (e.g., software object attribute 430).

Embodiments described herein may provide systems and/or methods that implement modification requests and/or notifications based on instance attributes and/or notification parameters, respectively.

Embodiments described herein may provide a variety of advantages. For example, because a portion (e.g., a sub-attribute) of an instance attribute may be modified via a modification request described herein, the modification request may be smaller in size. Thus, less bandwidth may be required to transfer the modification request, and the client may require less time and less processing cycles to construct the modification request. With the modification request, the client does not need to read the entire instance attribute into memory, modify the sub-attribute into memory, and request modification of the entire instance attribute. Rather, the client may generate a modification request describing the modified sub-attribute. The modification request may also reduce the chances of data corruption for multiple clients because the multiple clients may not need to maintain recent changes by other clients. Instead, the multiple clients may modify sub-attribute(s) without taking into account changes by other clients. Furthermore, a server may require less time to decode the modification request, and modify the portion of the instance attribute (e.g., provided in a MIB).

The server may broadcast the modified portion (e.g., a sub-attribute) of the instance attribute to other clients via a notification described herein. Thus, the notification may be smaller in size, less bandwidth may be required to transfer the notification, and the server may require less time and less processing cycles to construct the notification. The clients receiving the notification may require less time and less processing cycles to detect the modified portion of the instance attribute since they receive (e.g., via the notification) the modified portion of the instance attribute and not the entire instance attribute.

The foregoing description of embodiments provides illustration and description, but is not intended to be exhaustive or to limit the invention to the precise form disclosed. Modifications and variations are possible in light of the above teachings or may be acquired from practice of the invention. For example, while series of blocks have been described with regard to FIGS. 7-13, the order of the blocks may be modified in other embodiments. Further, non-dependent blocks may be performed in parallel.

It should be emphasized that the term “comprises/comprising” when used in this specification is taken to specify the presence of stated features, integers, steps or components but does not preclude the presence or addition of one or more other features, integers, steps, components or groups thereof.

It will be apparent that exemplary embodiments, as described above, may be implemented in many different forms of software, firmware, and hardware in the embodiments illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. The logic may include hardware, such as an application specific integrated circuit, a field programmable gate array, a processor, or a microprocessor, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, performed by a device associated with a network, comprising:
receiving a request to modify a sub-attribute of an attribute associated with a software object that represents one of a representation of a managed resource or a collection of attributes associated with the managed resource;
modifying the sub-attribute of the software object based on the request; and
sending a notification about the sub-attribute that has been modified.

2. A method, performed by a device associated with a network, comprising:
receiving a request to modify a sub-attribute of an instance attribute;
identifying an instance based on the request;
identifying an attribute of the identified instance based on the request;
identifying a sub-attribute of the identified attribute based on the request;
identifying a sub-attribute value based on the request;
identifying an operation based on the request; and
performing the operation on the identified sub-attribute, with the identified sub-attribute value, to produce the modified sub-attribute of the instance attribute.

3. The method of claim 2, where further comprising:
storing the modified sub-attribute of the instance attribute in a database.

4. The method of claim 2, where receiving a request comprises:
receiving a request that includes a selection criteria parameter and a modification parameter; and the method further comprises one or more of:
identifying the instance based on the selection criteria parameter,
identifying the attribute of the identified instance based on the modification parameter,
identifying the operation based on the modification parameter,
identifying the sub-attribute of the identified attribute based on the modification parameter, or
identifying the sub-attribute value based on the modification parameter.

5. The method of claim 2, where performing the operation on the identified sub-attribute comprises one of:
adding a new sub-attribute to the identified attribute;
removing the identified sub-attribute from the identified attribute;
removing all sub-attributes from the identified attribute; or
replacing the identified sub-attribute with a new value.

6. The method of claim 2, further comprising:
generating a notification that includes the modified sub-attribute of the instance attribute.

7. The method of claim 6, where generating a notification comprises one or more of:
providing a class parameter via the notification;
providing an instance identifier parameter via the notification;
providing a notification identifier parameter via the notification;
providing a notification time parameter via the notification;
providing a notification type parameter via the notification; or
providing a change sub-attribute parameter via the notification.

8. The method of claim 7, where providing a change sub-attribute parameter comprises one or more of:
providing an attribute identifier element via the change sub-attribute parameter;
providing a complex data structure element via the change sub-attribute parameter;
providing an operation element via the complex data structure element;
providing a sub-attribute identifier element via the complex data structure element; or
providing a sub-attribute value element via the complex data structure element.

9. A method, performed by a device associated with a network, comprising:
providing a request to modify a sub-attribute of an instance attribute to an instance storage device; and
receiving, from the instance storage device, a notification of modification of the sub-attribute of the instance attribute.

10. The method of claim 9, where providing a request comprises:
providing, via the request, a selection criteria parameter that allows the instance storage device to select the instance attribute; and
providing, via the request, a modification parameter that allows the instance storage device to modify the sub-attribute.

11. The method of claim 10, where providing a modification parameter comprises:
providing an attribute identifier element via the modification parameter;
providing an operation element via the modification parameter;
providing a sub-attribute identifier element via the modification parameter; and
providing a value element via the modification parameter.

12. The method of claim 11, where the instance storage device utilizes the operation element, the sub-attribute identifier element, and the value element to produce the modification of the sub-attribute of the instance attribute.

13. The method of claim 9, where receiving, from the instance storage device, a notification comprises one or more of:
receiving a class parameter via the notification;
receiving an instance identifier parameter via the notification;
receiving a notification identifier parameter via the notification;
receiving a notification time parameter via the notification;
receiving a notification type parameter via the notification; or
receiving a change sub-attribute parameter via the notification.

14. A device associated with a network, comprising:
processing logic to:
receive a request to modify a sub-attribute of an instance attribute,
identify an instance based on the request,
identify an attribute of the identified instance based on the request,
identify a sub-attribute of the identified attribute based on the request,
identify a sub-attribute value based on the request,
identify an operation based on the request,
perform the operation on the identified sub-attribute, with the identified sub-attribute value, to produce the modified sub-attribute of the instance attribute, and
store the modified sub-attribute of the instance attribute in a database.

15. The device of claim 14, where the database comprises a Management Information Base (MIB)

16. The device of claim 14, where the instance comprises at least one of:
a representation of a managed resource; or
a collection of attributes associated with the managed resource.

17. The device of claim 16, where the representation of a managed resource comprises at least one of:
a network node under management;
a network function under management; or
a network communication link under management.

18. The device of claim 14, where the request comprises:
a selection criteria parameter that allows the device to identify the instance; and
a modification parameter that allows the device to modify the identified sub-attribute.

19. The device of claim 18, where the processing logic is further configured to:
identify the instance based on the selection criteria parameter,
identify the attribute of the identified instance based on the modification parameter,
identify the operation based on the modification parameter,
identify the sub-attribute of the identified attribute based on the modification parameter, and
identify the sub-attribute value based on the modification parameter.

20. The device of claim 14, where, when performing the operation on the identified sub-attribute, the processing logic is further configured to one of:
add a new sub-attribute to the identified attribute,
remove the identified sub-attribute from the identified attribute,
remove all sub-attributes from the identified attribute, or
replace the identified sub-attribute with a new value.

21. The device of claim 14, where the device comprises a server device.

22. The device of claim 14, where the processing logic is further configured to:
generate a notification that includes the modified sub-attribute of the instance attribute.

23. The device of claim 22, where the notification comprises:
a class parameter;
an instance identifier parameter;
a notification identifier parameter;
a notification time parameter;
a notification type parameter; and
a change sub-attribute parameter.

24. The device of claim 23, where the change sub-attribute parameter comprises:
an attribute identifier element;
an operation element;
a sub-attribute identifier element; and
a sub-attribute value element.

25. A device associated with a network, comprising:
processing logic to:
provide a request to modify a sub-attribute of an instance attribute to an instance storage device, and
receive, from the instance storage device, a notification of modification of the sub-attribute of the instance attribute.

26. The device of claim 25, where the device comprises a client device.

27. The device of claim 25, where the request comprises:
a selection criteria parameter; and
a modification parameter.

28. The device of claim 27, where the modification parameter comprises:
an attribute identifier element;
an operation element;
a sub-attribute identifier element; and
a value element.

29. The device of claim 25, where the notification comprises:
a class parameter;
an instance identifier parameter;
a notification identifier parameter;
a notification time parameter;
a notification type parameter; and
a change sub-attribute parameter.

30. The device of claim 29, where the change sub-attribute parameter comprises:
an attribute identifier element;
an operation element;
a sub-attribute identifier element; and
a sub-attribute value element.

31. A device associated with a network, comprising:
processing logic to:
receive a request to modify a sub-attribute of an attribute associated with a software object that represents one of a representation of a managed resource or a collection of attributes associated with the managed resource,
modify the sub-attribute of the software object based on the request, and
send a notification about the sub-attribute that has been modified.
